(19) United States
(12) Patent Application Publication
(10) Pub. No.: US 2016/0013751 A1
(43) Pub. Date: Jan. 14, 2016

(54) SOLAR FACILITY WITH A PLURALITY OF IN-LINE TRACKER SUPPORT SYSTEMS

(71) Applicants: OPTIMUM TRACKER, Meyreuil (FR); PRESTIGE SOLAIRE, Meyreuil (FR)

(72) Inventors: Madyan MICHOTTE DE WELLE, Saint Martin De Crau (FR); Yacin MICHOTTE DE WELLE, Saint Martin De Crau (FR)

(21) Appl. No.: 14/765,733

(22) PCT Filed: Feb. 4, 2014
(86) PCT No.: PCT/FR2014/050203

§ 371 Date: Aug. 4, 2015

(30) Foreign Application Priority Data
Feb. 5, 2013 (FR) 1350975

(51) Int. Cl. H02S 20/32

(52) U.S. Cl. CPC H02S 20/32

(57) ABSTRACT

A linearly-arranged solar array (1) comprising at least two tracking support systems (2) for solar panels, wherein each tracking support system (2) can be oriented according to one single main axis of rotation (20), wherein the tracking support systems (2) are aligned on the same line with their main axes of rotation (20) being coincident, wherein each tracking support system (2) comprises:
a fixed ground anchor structure (21);
a movable structure including a platform (22) for supporting the solar panels, rotatably mounted on the fixed structure (21) about the main axis of rotation (20);
a mechanical system (24) for driving the movable structure in rotation about the main axis of rotation (20).

The array comprises an actuation system (3) which is common to the tracking support systems (2), coupled to their mechanical drive systems (24) via a mechanical transmission device (4) extending parallel to the main axis of rotation, so that the platforms (22) are driven in rotation concomitantly by said actuation system (3) by means of the transmission device (4) and the mechanical drive systems (24).

The present invention relates to a linearly-arranged solar array comprising at least two tracking support systems for solar panels, and to a solar field integrating at least two linearly-arranged solar arrays in parallel.

The object of the invention relates to the field of tracking support systems, also called solar trackers, and specifically, to tracking support systems that can be oriented according to one single main axis of rotation, in order to follow the Sun as it rises and goes down from East to West. For information, such a main axis of rotation extends substantially parallel to the ground to which the tracking support system is anchored.

Such tracking support systems are often combined in line (extending from North to South) within linearly-arranged solar arrays, and these linearly-arranged solar arrays are, in turn, duplicated so as to form a solar field which may integrate several tens, and even several thousands, of tracking support systems.

In solar fields that integrate several linearly-arranged solar arrays, it is known, in particular from documents ES 2 368402, US 2008/308091 and EP 2 317 247, to mount several movable platforms, side-by-side, in order to form lines which are driven in rotation by means of a cross transmission system. Thus, all movable platforms are rotatably coupled perpendicular to the main axis of rotation.

Furthermore, these documents describe a rotational coupling between parallel linearly-arranged arrays by setting up connecting bars which extend perpendicular to the lines in order to connect together the movable platforms, and which extend across and in the middle of the alleys bordered by the linearly-arranged arrays. These connecting bars are positioned between two platforms, in particular at the middle of horizontal beams, and consequently across the alleys, so that the torque that is exerted by the connecting bars on the beams is sufficient for rotating each beam from end to end. Such connecting bars constitute a real inconvenience for the traffic of vehicles in these alleys, such as for example vehicles intended for cleaning the solar panels, for transport of personnel and maintenance and repair equipment, etc.

The present invention aims to solve these drawbacks by providing a linearly-arranged solar array which exhibits a simple design and which offers the possibility of traffic of vehicles in the alleys bordered by such arrays.

To this end, it provides a linearly-arranged solar array comprising at least two tracking support systems for solar panels, wherein each tracking support system can be oriented according to one single main axis of rotation, wherein the tracking support systems are aligned on the same line with their main axes of rotation being substantially coincident, said solar array being characterized in that each tracking support system comprises:
a fixed ground anchor structure;
a movable structure including a platform for supporting the solar panels, rotatably mounted on the fixed structure about the main axis of rotation;
a mechanical system for driving the movable structure in rotation about the main axis of rotation, said mechanical drive system comprising a movable device mounted on the fixed structure in an offset manner with respect to the main axis of rotation, and a connecting element coupled to said movable device and connected to said platform so that a motion of said movable device results in a rotation of said platform via the connecting element;

and in that the array further comprises an actuation system which is common to said tracking support systems, said actuation system being coupled to their mechanical drive systems via a mechanical transmission device extending parallel to the main axis of rotation, said transmission device being coupled to the movable devices of the mechanical drive systems of each tracking support system, so that the platforms are driven in rotation concomitantly by said actuation system by means of the transmission device and the mechanical drive systems.

Thus, the array is realized from several tracking support systems each having its own fixed structure, its own movable structure with the platform, and its own mechanical system for driving the movable structure in rotation; the synchronous rotation of the platforms being achieved by an actuation system which is common to the linearly-arranged array, this common actuation system being coupled to different mechanical drive systems by a transmission device which is distinct from the movable structure and mounted in an offset manner with respect to the main axis of rotation, thereby facilitating the mounting and maintenance of the array. This transmission device extends parallel to the main axis of rotation in order not to disturb the traffic of vehicles in the adjacent alleys.

The platform of the movable structure of a tracking support system may comprise one or several beams, each beam being parallel to the main axis of rotation. As a non-limiting example, the platform may optionally comprise several cross-members perpendicular to the axis of rotation and secured on each beam. Of course, the solar panels may be directly secured on the beam(s).

Of course, in a solar field which integrates several lines of solar panels, it is possible to have several linearly-arranged solar arrays in accordance with the invention, on the same line. In fact, with lines of solar panels extending over several hundreds of meters, with several tens of tracking support systems per each line, it is advantageous, for mechanical reasons, to have several linearly-arranged solar arrays disposed side-by-side and aligned on the same line, and hence, have several actuation systems per each line, always with one single actuation system per each linearly-arranged solar array which would be common to several tracking support systems. As will be described next, it is also possible to have one single actuation system that is common to two linearly-arranged solar arrays which are placed on two parallel and adjacent lines.

Moreover, it should be noted that the main axes of rotation are substantially parallel to the ground to which the array is anchored, and that, for the same linearly-arranged array, these main axes of rotation are substantially coincident, in the sense that they may be completely coincident in the case where all tracking support systems have been anchored to a flat even ground, but theses main axes of rotation may be substantially tilted with respect to each other in the case where the tracking support systems of the same array are anchored to a slightly hilly ground.

According to the invention, the platforms of the tracking support systems are not directly connected to each other and they are spaced apart by a predetermined distance along the main axis of rotation.

According to one feature, the actuation system is secured on the fixed structure or on the mechanical drive system of either one of the tracking support systems, in particular on a central tracking support system.

According to another feature, the movable device of the mechanical drive system of each tracking support system is disposed below the corresponding platform, and the transmission device extends below the platforms of the tracking support systems.

According to another feature, the platform of each tracking support system comprises a central beam rotatably mounted on the fixed structure about the main axis of rotation, and the connecting element of each mechanical drive system is fixedly mounted on said central beam, preferably in the proximity of a rotation bearing of the central beam on the fixed structure.

According to another feature, the transmission device comprises either one of the devices that are listed below:
cable and pulley transmission;
chain and sprocket transmission;
belt and pulley transmission;
cables transmission;
rotary driveshaft transmission with a bevel gear mechanism.

In a first embodiment, the mechanical drive system of each tracking support system is of the type comprising a ring gear sector meshing with a gearwheel, in particular a worm screw, said gearwheel being rotatably coupled to the transmission device and rotatably mounted on a bearing secured on the fixed structure, and the ring gear sector is secured to the platform, the ring gear sector and the gearwheel respectively forming the connecting element and the movable device of the mechanical drive system.

Such a solution is particularly advantageous in terms of robustness and reliability of the rotation of the platforms. In one embodiment with one single beam per each tracking support system, the ring gear sector may be directly secured to the beam. In another embodiment with two beams or more per each tracking support system, the ring gear sector may be secured to a cross-member which is, in turn, secured to the beams.

In a second embodiment, the mechanical drive system of each tracking support system is of the type comprising a parallel link mechanism comprising:
two lower arms exhibiting lower ends which are coupled together on a lower hinge which is pivotally coupled on the fixed structure about an axis parallel to the main axis of rotation;
two upper arms exhibiting upper ends which are coupled together on an upper hinge, each upper arm exhibiting a lower end which is hinged on an upper end of a lower arm so as to form first and second central hinges; and
a transmission arm exhibiting a first end which is pivotally coupled on the upper hinge about an axis parallel to the main axis of rotation, and a second end which is rotatably secured to the platform,

wherein the transmission device is connected to the central hinges formed between the lower and upper arms in order to displace said central hinges toward and away from each other, the transmission arm and the assembly (so-called, the parallel link assembly) that integrates the lower and upper arms respectively forming the connecting element and the movable device of the mechanical drive system.

Such a solution is particularly advantageous in terms of robustness and cost, and it has the benefit of a particularly reduced wear of the parts that constitute the parallel link mechanism. Moreover, it is advantageously possible to consider such a mechanical drive system on an independent tracking support system which has its own actuation system.

Advantageously, according to this second embodiment, the actuation system consists of an actuating cylinder and it includes a body secured on either one of the lower and upper arms at the first central hinge of a mechanical drive system of either one of the tracking support systems, and a rod movable inside the body and exhibiting an end secured to the second central hinge of said mechanical drive system.

Still advantageously, according to this second embodiment, the transmission device consists of a cable type transmission and it includes two cables respectively fastened to the first and second central hinges of the mechanical drive systems of each tracking support system.

In a third embodiment, the mechanical drive system of each tracking support system is of the type comprising a nut in which a threaded rod is engaged, said nut being pivotally mounted on the fixed structure via an axle perpendicular to the threaded rod, and said threaded rod exhibiting a lower end rotatably coupled to the transmission device and an upper end coupled to a first end of a transmission arm via a ball joint connection, said transmission arm exhibiting an opposite second end rotatably secured to the platform, the transmission arm and the threaded rod respectively forming the connecting element and the movable device of the mechanical drive system.

Such a solution is particularly advantageous in terms of robustness and durability.

Advantageously, the actuation system consists of a rotary motor or an actuating cylinder.

The invention also relates to a solar field of the type comprising at least two linearly-arranged solar arrays, each linearly-arranged solar array comprising at least two tracking support systems for solar panels, wherein each tracking support system can be oriented according to one single main axis of rotation and comprises:
a fixed ground anchor structure;
a movable structure including a platform for supporting the solar panels, rotatably mounted on the fixed structure about the main axis of rotation;
a mechanical system for driving the platform in rotation about the main axis of rotation, said mechanical drive system comprising a movable device mounted on the fixed structure in an offset manner with respect to the main axis of rotation, and a connecting element coupled to said movable device and connected to said platform so that a motion of said movable device results in a rotation of said platform via the connecting element;

wherein said linearly-arranged solar arrays extend substantially parallel to each other and at least one of the solar arrays is in accordance with the invention.

According to a first possibility, the two solar arrays are in accordance with the invention. Thus, the rotational motions of the two arrays are independent, therefore, there is no material obstacle which can disturb the traffic in the alley bordered by these two arrays.

According to a second possibility:
a first solar array is in accordance with the invention, and
a second solar array includes a transmission device rotatably coupling the mechanical drive systems of its tracking support systems in order to ensure a synchronous rotation of the platforms of these tracking support systems, said transmission device being coupled to the movable devices of the mechanical drive systems of each tracking support system of said second solar array;

and the field further comprises at least one connection between the transmission device of the first array and the transmission device of the second array, so that the platforms of the second array are driven in rotation by the actuation system of the first array, concomitantly with the platforms of the first array, by means of the connection(s) between the two arrays.

Thus, the rotational motions of the two arrays are dependent of each other, with the actuation system of the first array ensuring the rotation of the platforms of the two arrays. Thus, the arrays are referred to as a pair of coupled arrays. The rotation of the platforms of the first array is transmitted to those of the second array thanks to the connection(s). Thus, a vehicle can circulate between two pairs of coupled arrays, therefore at least between two rows, along the entire length of the alley which separates two such pairs of coupled arrays, without any restriction. The connection is advantageously, but not necessarily, disposed at the extremities of the arrays in order to limit the inconvenience.

Other features and advantages of the present invention will appear upon reading the following detailed description, of three non-limiting embodiments, with reference to the appended figures in which:

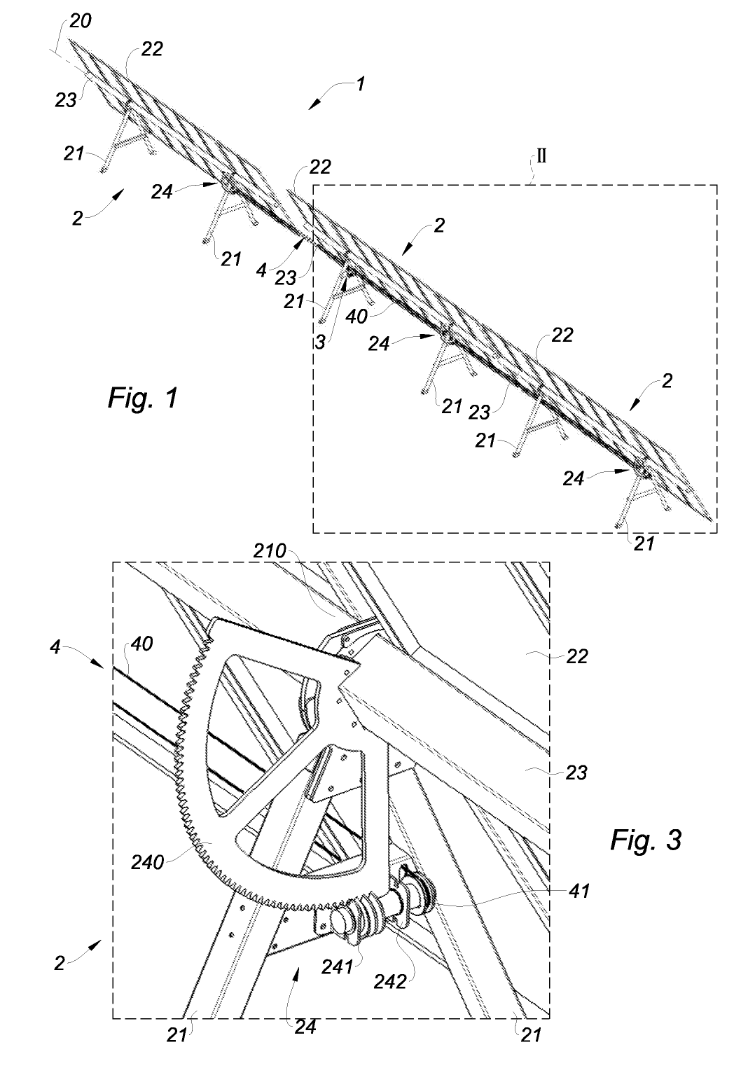

FIG. 1 is a schematic perspective view of a linearly-arranged solar array in accordance with a first embodiment of the invention;

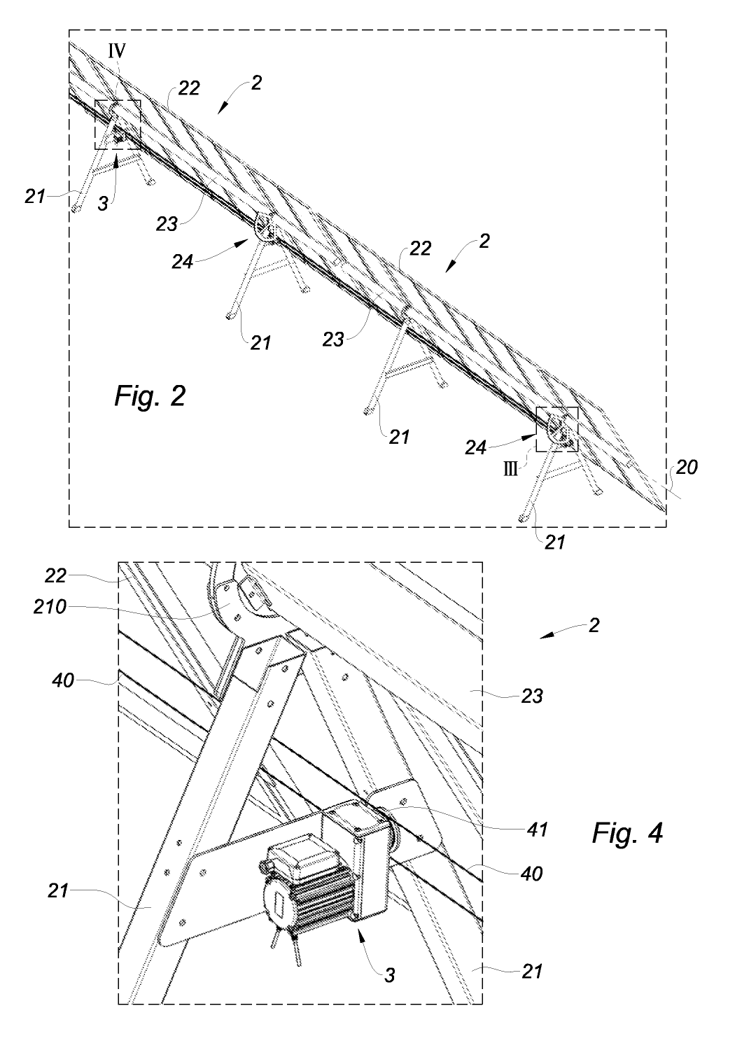

FIG. 2 is an enlarged view of the area II of FIG. 1;

FIG. 3 is an enlarged view of the area III of FIG. 2;

FIG. 4 is an enlarged view of the area IV of FIG. 2;

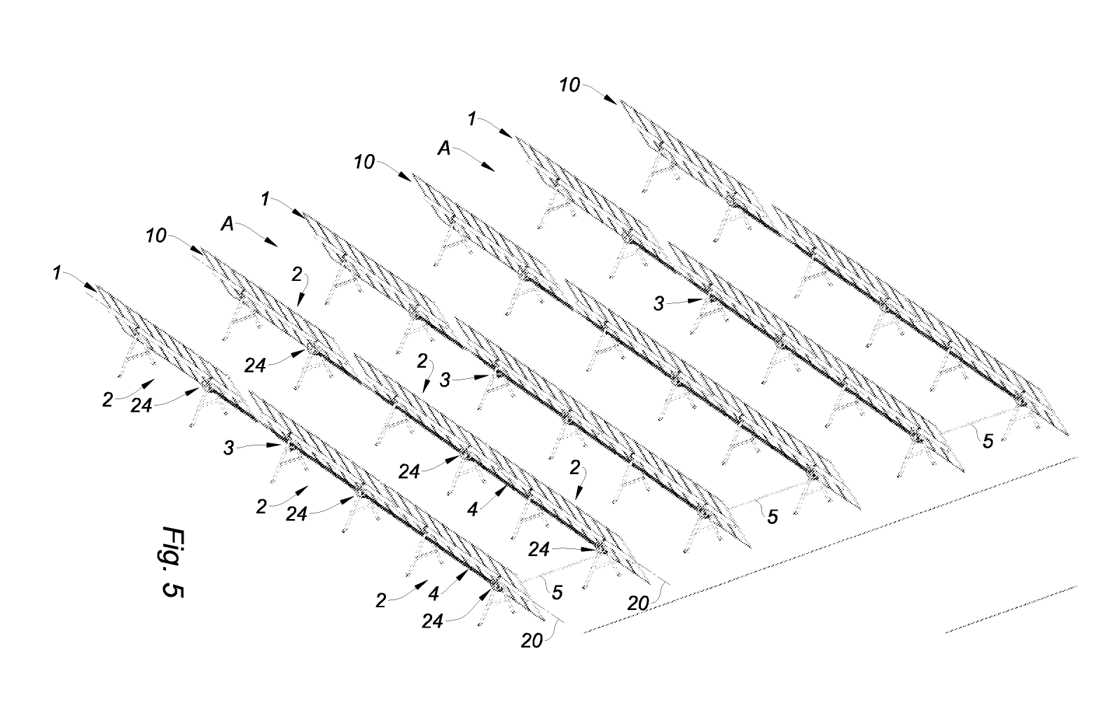

FIG. 5 is a schematic perspective view of a solar field in accordance with the invention which integrates several solar arrays in accordance with the first embodiment of the invention;

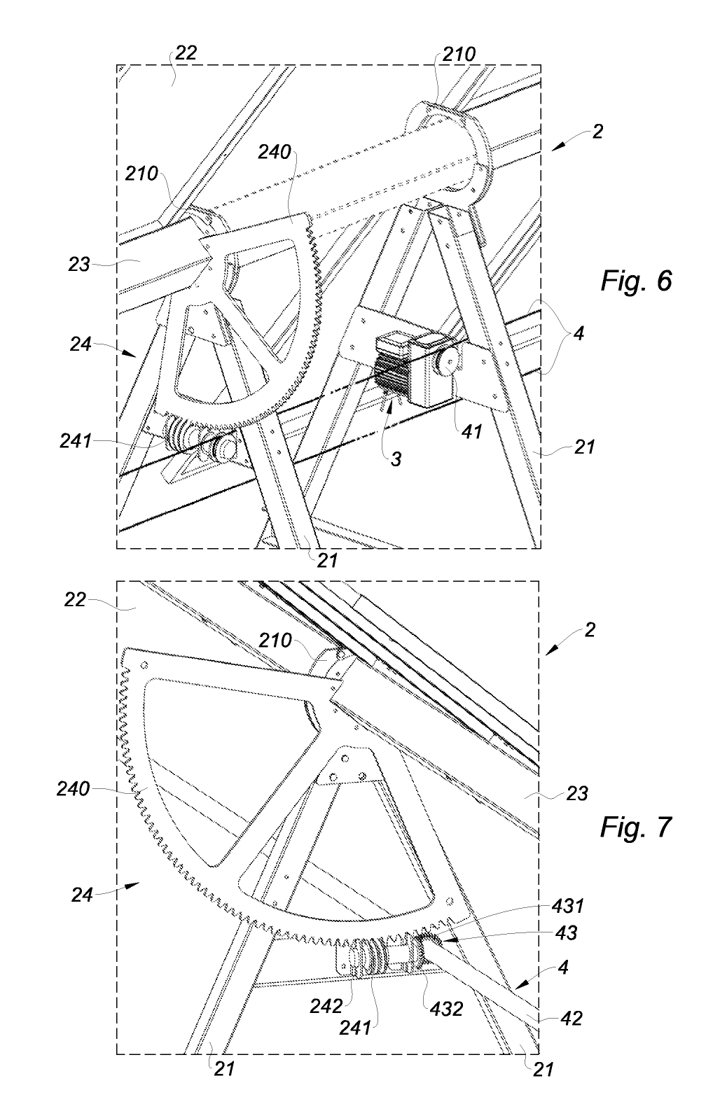

FIG. 6 is a schematic partial perspective view of a linearly-arranged solar array in accordance with the first embodiment of the invention, including a variant of the transmission device;

FIG. 7 is a schematic partial perspective view of a linearly-arranged solar array in accordance with the first embodiment of the invention, including another variant of the transmission device;

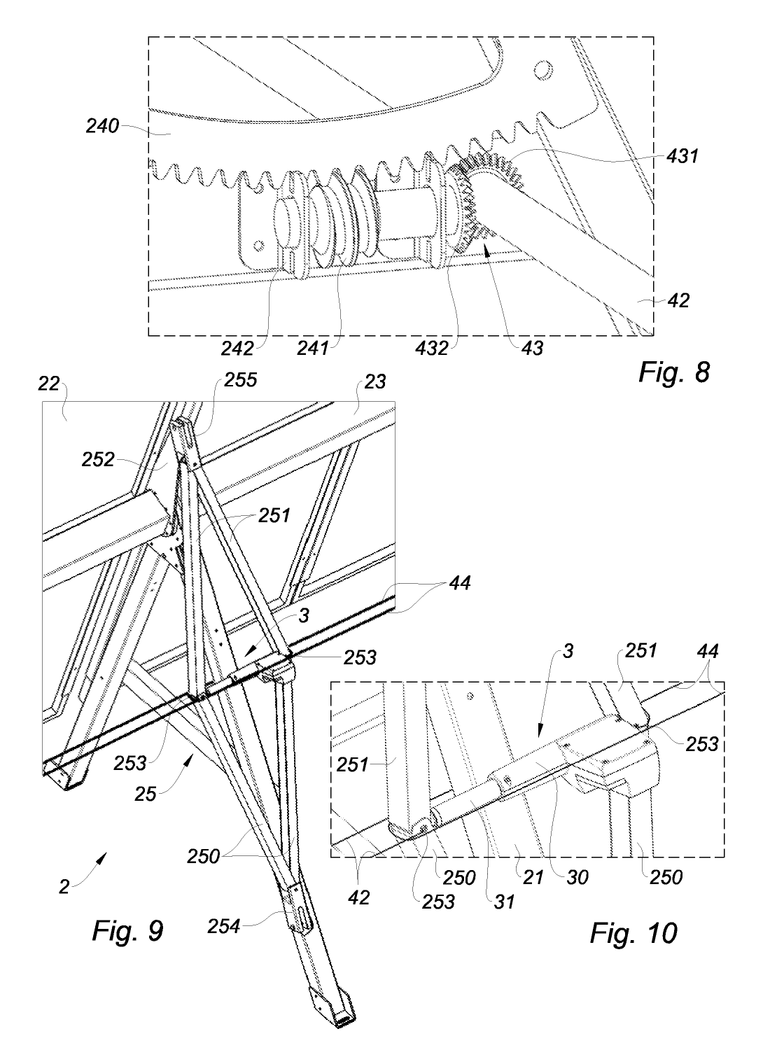

FIG. 8 is an enlarged view of a portion of FIG. 7;

FIG. 9 is a schematic partial perspective view of a linearly-arranged solar array in accordance with a second embodiment of the invention;

FIG. 10 is an enlarged view of a portion of FIG. 9;

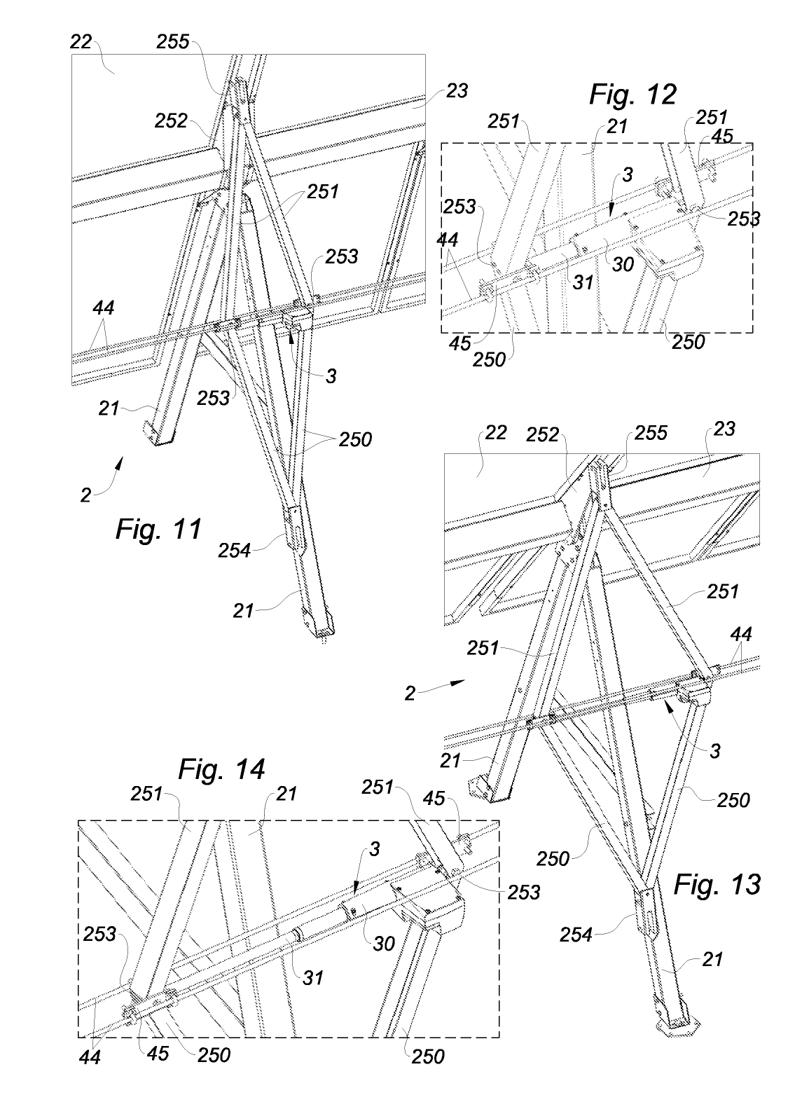

FIG. 11 is a schematic partial perspective view of a linearly-arranged solar array in accordance with the second embodiment of the invention, including a variant of the transmission device, and where the platform is in a first position;

FIG. 12 is an enlarged view of a portion of FIG. 11;

FIG. 13 is a schematic partial perspective view of the array of FIG. 11, where the platform is in a second position;

FIG. 14 is an enlarged view of a portion of FIG. 13;

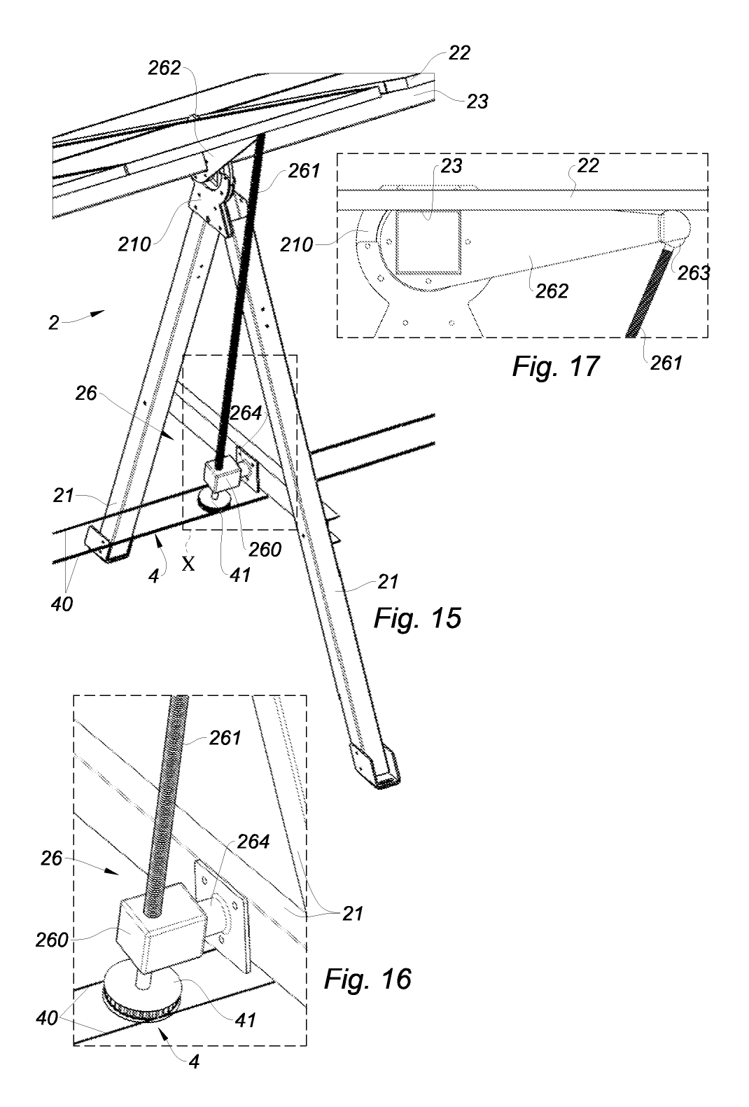

FIG. 15 is a schematic partial perspective view of a linearly-arranged solar array in accordance with a third embodiment of the invention;

FIG. 16 is an enlarged view of the area X of FIG. 15;

FIG. 17 is a schematic side view of a portion of the array of FIG. 15.

Referring to FIGS. 1 to 17, a linearly-arranged solar array 1 in accordance with the invention comprises several tracking support systems 2 for solar panels, wherein each tracking support system 2 can be oriented according to one single main axis of rotation 20.

Within the same solar array 1, the tracking support systems 2 are aligned on the same line with their main axes of rotation 20 substantially coincident, while considering the clearances due to mounting and on-site installation and the defects of the ground (irregularities of the terrain, defective planarity, etc.).

This tracking support system 2 comprises:
a fixed ground anchor structure 21;
a movable structure including a platform 22 for supporting the solar panels, which integrates a central beam 23, the beam 23 being rotatably mounted on the fixed structure 21 about the main axis of rotation 20, inside two upper bearings 210 (visible in FIGS. 3, 4, 6 and 7) and supported by the fixed structure 21;
a mechanical system 24, 25, 26 for driving the movable structure 22, 23 in rotation about the main axis of rotation 20.

In the embodiments that are illustrated in the figures, the fixed structure 21 comprises two bases spaced apart along the main axis of rotation 20 and each including two ground anchor feet. Each of the two bases of the fixed structure 21 supports an upper bearing 210, the beam 23 being rotatably mounted in these two bearings 210. Anchoring the fixed structure 21 to the ground may be achieved by means of anchor piles, preferably one pile per each foot, and/or by means of counterweights. Of course, the fixed structure 21 may be realized in other forms, in particular in the form of a pylon or a post.

The platforms 22, and hence the beams 23, are not connected to each other, and the beams 23 of two adjacent tracking support systems 2 are spaced apart by a predetermined distance. Of course, it is possible to have at least two parallel beams 23, instead of one single beam 23.

In the first embodiment illustrated in FIGS. 1 to 8, the mechanical drive system 24 includes a ring gear sector 240 meshing with a worm screw type gearwheel 241. The gearwheel 241 is rotatably mounted on a bearing 242 secured on the fixed structure 21 about a direction perpendicular to the main axis of rotation 20, wherein the bearing 242 is constituted by a caliper with two parallel flanges which support the gearwheel 241. The ring gear sector 240 is secured on the beam 23 and extends perpendicular to the main axis of rotation 20, and hence, to the beam 23. Thus, a rotation of the gearwheel 241 results in a rotation of the ring gear sector 240 and consequently in a rotation of the movable structure 22, 23 in the bearings 210. In other words, the beam 23 rotates the bearings 210.

In the second embodiment illustrated in FIGS. 9 to 14, the mechanical drive system 25 includes a parallel link mechanism comprising:
two lower arms 250 exhibiting lower ends which are coupled together on a lower hinge 254 (a cardan-type joint) which is pivotally coupled on the fixed structure 21 (at its lower portion) about a pivot axis parallel to the main axis of rotation 20;
two upper arms 251 exhibiting upper ends which are coupled together on an upper hinge 255 (a cardan-type joint), each upper arm 251 exhibiting a lower end which is hinged on an upper end of a lower arm 250 so as to form first and second central hinges 253 formed between the lower arms 250 and the upper arms 251; and
a transmission arm 252 exhibiting a first end which is pivotally coupled on the upper hinge 255 about a pivot axis parallel to the main axis of rotation 20, and a second end which is rotatably secured to the beam 23.

From a functional point of view, by displacing the central hinges 253 formed between the lower arms 250 and the upper arms 251 horizontally away from each other, the first end of the transmission arm 252 is pulled downward, and therefore, the beam 23, and hence the platform 22, are rotated in one direction, whereas by displacing these central hinges 253 horizontally toward each other, the first end of the transmission arm 252 is pushed upward, and therefore, the platform 22 is rotated in the opposite direction. FIGS. 9 to 12 illustrate a first configuration with the central hinges 253 being brought close to each other, whereas FIGS. 13 and 14 illustrate a second configuration with the central hinges 253 being spaced apart from each other.

In the third embodiment illustrated in FIGS. 15 to 17, the mechanical drive system 26 comprises a threaded rod 261 engaged in a nut 260, this nut 260 being pivotally mounted on the fixed structure 21 via a horizontal axle 264 perpendicular to the threaded rod 261. The threaded rod 261 exhibits an upper end coupled to the beam 23 via a transmission arm 262. More precisely, the upper end of the threaded rod 261 is coupled to a first end of the transmission arm 262 via a ball joint connection 263. Furthermore, this transmission arm 262 exhibits an opposite second end rotatably secured to the beam 23.

From a functional point of view, by rotating the threaded rod 261 in either direction, the threaded rod 261 is raised or lowered in the nut 260 which pivots on the axle 264 in order to follow the motion, so that the first end of the transmission arm 262 is pushed upward or pulled downward, and therefore, the beam 23, and hence the platform 22, are rotated in either direction.

In accordance with the invention, the array 1 further comprises an actuation system 3 which is common to all tracking support systems 2, in order to rotate their respective platforms 22 in a synchronous manner.

This actuation system 3, which consists of a power actuator, is coupled to mechanical drive systems 24, 25, 26 of all these tracking support systems 2, via a mechanical transmission device 4 extending parallel to the beams 23. Thus, this actuation system acts on all mechanical drive systems 24, 25, 26 in order to rotate all platforms 22 of the same array 1, at the same time. Of course, as has been described before, it is possible to have several linearly-arranged solar arrays in accordance with the invention which are placed on the same line, and which are then aligned and disposed successively side-by-side.

In the first embodiment and as is illustrated in FIGS. 4 and 6, the actuation system 3 is constituted by a rotary motor which rotates an output shaft, and the rotation of this output shaft causes the displacement of all mechanical drive systems 24, 25, 26 by means of the transmission device 4, and hence, it causes the concomitant rotation of all platforms 22 of the same array 1.

As can be seen in FIGS. 4 and 6, the rotary motor 3 is secured on the fixed structure 21 of either one of the tracking support systems 2, and in particular, on a central tracking support system 2, as can be seen in FIG. 1.

In order to convert the rotation of the rotary motor 3 into a displacement of the mechanical drive systems 24, 25, 26, several transmission devices 4 may be considered.

In a first variant of the first embodiment which is illustrated in FIGS. 1 to 4 and 6, the transmission device 4 consists of a cable 40 and pulley 41 type transmission. As can be seen in FIGS. 4 and 6, one or several cables 40 are arranged in a loop and coupled to a pulley 41 which is rotatably secured to the output shaft of the rotary motor 3 and, as can be seen in FIG. 3, this or these cable(s) 40 are coupled to other pulleys 41 which are rotatably secured to the gearwheels 241 of the mechanical drive systems 24. In the embodiment of FIGS. 3 and 4, two strands of each cable 40 are coupled to the pulleys 41, whereas in the embodiment of FIG. 6, one single strand of each cable 40 is coupled to the pulleys 41 by forming loops around these pulleys.

It is also possible to provide a belt and pulley transmission (by replacing each cable 40 by a belt) or a chain and sprocket transmission (by replacing each cable 40 by a chain and the pulleys by sprockets).

In a second variant of the first embodiment which is illustrated in FIGS. 7 and 8, the transmission device 4 consists of a rotary driveshaft 42 type transmission with bevel gear mechanisms 43. To this end, the transmission device 4 includes a rotary driveshaft 42, extending parallel to the beam 23 and to the main axis of rotation 20 and rotatably driven about its axis by a rotary motor 3. This transmission device 4 further includes bevel gear mechanisms 43 each composed of a first gearwheel 431 secured to the rotary driveshaft 42 and a second gearwheel 432 meshing with the first gearwheel 431 at a right angle, wherein the second gearwheels 432 are rotatably secured to the gearwheels 241 of the mechanical drive systems 24.

In the second embodiment of FIGS. 9 to 14, the actuation system 3 consists of a hydraulic or electric actuating cylinder, and it includes a body 30 secured on the parallel link mechanism 25, at a first central hinge 253 (shown at the right in the figures), and a rod 31 movable inside the body 30 and exhibiting an end secured to the second central hinge 253 (shown at the left in the figures).

In this second embodiment, the transmission device 4 consists of a cable type transmission 44. As can be seen in FIG. 10, a cable 44 (shown at the top in FIGS. 9 to 14) is fastened to the first central hinge 253 of the parallel link mechanism 25, whereas another cable 44 (shown at the bottom in FIGS. 9 to 14) is fastened to the second central hinge 253.

In the variant of FIGS. 9 and 10, the cables 44 are fastened on the corresponding hinges 253 by forming a reverse loop. In the variant of FIGS. 11 to 14, the cables 44 are fastened on the corresponding hinges 253 by means of calipers 45.

Thus, by displacing the central hinges 253 toward or away from each other, the two cables 44 pull the hinges of the other parallel link mechanisms, and therefore, all platforms 22 pivot in a synchronous manner.

Of course, in this second embodiment, it is possible to consider replacing the actuating cylinder by a rotary motor which pulls the cables 44 horizontally in order to displace the central hinges 253 of all parallel link mechanisms toward and away from each other.

In the third embodiment illustrated in FIGS. 15 to 17, the transmission device 4 consists of a cable (40) and pulley (41) type transmission. To this end, the transmission device 4 includes one or several cables 40 arranged in a loop and coupled to pulleys 41 which are rotatably secured to the threaded rods 261 of the mechanical drive systems 26.

FIG. 5 illustrates a solar field which integrates several solar arrays 1 in accordance with the invention. It is possible to integrate only but solar arrays 1 that are in accordance with the invention. However, in the embodiment illustrated in FIG. 5, solar arrays 1 that are in accordance with the invention, so-called the first arrays, are alternated with second arrays 10 that are devoid of actuation systems. These second arrays 10 are almost identical to the first arrays, except that they comprise no actuation systems 3.

The transmission device 4 of the first array 1 is connected to the transmission device 4 of the second array 10 by a connection 5, in particular a connecting rotary driveshaft exhibiting a first end rotatably coupled to a pulley 41 of the transmission device 4 of the first array 1, and a second end rotatably coupled to a pulley 41 of the transmission device 4 of the second array 10. This connection 5 is advantageously, but not necessarily, disposed at the extremities of the arrays 1, 10.

Thus, the rotation of the rotary motor 3 of the first array 1 is transmitted to the platforms 22 of the second array 10 via the connection 5 and via the transmission device 4 of the second array 10.

Thus, it is possible to circulate freely in the alleys A bordered by the two arrays 1, 10 which are paired together by a connection 5.

Of course, the above-mentioned embodiment is by no way limitative and other improvements and details may be brought to the solar array of the invention, without departing from the scope of the invention where other forms of the mechanical drive systems and/or the transmission device may, for example, be considered.

1. A linearly-arranged solar array comprising at least two tracking support systems for solar panels, wherein each tracking support system can be oriented according to one single main axis of rotation, wherein the tracking support systems are aligned on the same line with their main axes of rotation being substantially coincident, said solar array being wherein each tracking support system comprises:
a fixed ground anchor structure;
a movable structure including a platform for supporting the solar panels, rotatably mounted on the fixed structure about the main axis of rotation;
a mechanical system for driving the movable structure in rotation about the main axis of rotation, said mechanical drive system comprising a movable device mounted on the fixed structure in an offset manner with respect to the main axis of rotation, and a connecting element coupled to said movable device and connected to said platform so that a motion of said movable device results in a rotation of said platform via the connecting element;
and in that the array further comprises an actuation system which is common to said tracking support systems, said actuation system being coupled to their mechanical drive systems via a mechanical transmission device extending parallel to the main axis of rotation, said transmission device being coupled to the movable devices of the mechanical drive systems of each tracking support system, so that the platforms are driven in rotation concomitantly by said actuation system by means of the transmission device and the mechanical drive systems.

2. The solar array according to claim 1, wherein the platforms of the tracking support systems are not directly connected to each other and they are spaced apart by a predetermined distance along the main axis of rotation.

3. The solar array according to claim 1, wherein the actuation system is secured on the fixed structure or on the mechanical drive system of either one of the tracking support systems, in particular on a central tracking support system.

4. The solar array according to claim 1, wherein the movable device of the mechanical drive system of each tracking support system is disposed below the corresponding platform, and the transmission device extends below the platforms of the tracking support systems.

5. The solar array according to claim 1, wherein the platform of each tracking support system comprises a central beam rotatably mounted on the fixed structure about the main axis of rotation, and the connecting element of each mechanical drive system is fixedly mounted on said central beam, preferably in the proximity of a rotation bearing of the central beam on the fixed structure.

6. The solar array according to claim 1, wherein the transmission device comprises either one of the devices that are listed below:
cable and pulley transmission;
chain and sprocket transmission;
belt and pulley transmission;
cable transmission;
rotary driveshaft transmission with a bevel gear mechanism.

7. The solar array according to claim 1, wherein the mechanical drive system of each tracking support system is of the type comprising a ring gear sector meshing with a gearwheel, in particular a worm screw, said gearwheel being rotatably coupled to the transmission device and rotatably mounted on a bearing secured on the fixed structure, and the ring gear sector is secured to the platform, the ring gear sector and the gearwheel respectively forming the connecting element and the movable device of the mechanical drive system.

8. The solar array according to claim 1, wherein the mechanical drive system of each tracking support system) is of the type comprising:
two lower arms exhibiting lower ends which are coupled together on a lower hinge which is pivotally coupled on the fixed structure about an axis parallel to the main axis of rotation;
two upper arms exhibiting upper ends which are coupled together on an upper hinge, each upper arm exhibiting a lower end which is hinged on an upper end of a lower arm so as to form first and second central hinges; and
a transmission arm exhibiting a first end which is pivotally coupled on the upper hinge about an axis parallel to the main axis of rotation, and a second end which is rotatably secured to the platform,
wherein the transmission device is connected to the central hinges formed between the lower and upper arms in order to displace said central hinges toward and away from each other, the transmission arm and the assembly that integrates the lower and upper arms respectively forming the connecting element and the movable device of the mechanical drive system.

9. The solar array according to claim 8, wherein the actuation system consists of an actuating cylinder and it includes a body secured on either one of the lower and upper arms at the first central hinge of a mechanical drive system of either one of the tracking support systems, and a rod movable inside the body and exhibiting an end secured to the second central hinge of said mechanical drive system.

10. The solar array according to claim 8, wherein the transmission device consists of a cable type transmission and it includes two cables respectively fastened to the first and second central hinges of the mechanical drive systems of each tracking support system.

11. The solar array according to claim 1, wherein the mechanical drive system of each tracking support system is of the type comprising a nut in which a threaded rod is engaged, said nut being pivotally mounted on the fixed structure via an axle perpendicular to the threaded rod, and said threaded rod exhibiting a lower end rotatably coupled to the transmission device and an upper end coupled to a first end of a transmission arm via a ball joint connection, said transmission arm exhibiting an opposite second end rotatably secured to the platform, the transmission arm and the threaded rod respectively forming the connecting element and the movable device of the mechanical drive system.

12. The solar array according to claim 1, wherein the actuation system consists of a rotary motor or an actuating cylinder.

13. A solar field of the type comprising at least two linearly-arranged solar arrays, each linearly-arranged solar array comprising at least two tracking support systems for solar panels, wherein each tracking support system can be oriented according to one single main axis of rotation and comprises:
a fixed ground anchor structure;
a movable structure including a platform for supporting the solar panels, rotatably mounted on the fixed structure about the main axis of rotation;
a mechanical system) for driving the platform in rotation about the main axis of rotation, said mechanical drive system comprising a movable device mounted on the fixed structure in an offset manner with respect to the main axis of rotation, and a connecting element coupled to said movable device and connected to said platform so that a motion of said movable device results in a rotation of said platform via the connecting element;
wherein said linearly-arranged solar arrays extend substantially parallel to each other and at least one of the solar arrays is in accordance with claim 1.

14. The solar field according to claim 13, wherein each solar array at least two tracking support systems for solar panels, wherein each tracking support system can be oriented according to one single main axis of rotation, wherein the tracking support systems are aligned on the same line with their main axes of rotation being substantially coincident, said solar array being wherein each tracking support system comprises:
a fixed ground anchor structure;
a movable structure including a platform for supporting the solar panels, rotatably mounted on the fixed structure about the main axis of rotation;
a mechanical system for driving the movable structure in rotation about the main axis of rotation, said mechanical drive system comprising a movable device mounted on the fixed structure in an offset manner with respect to the main axis of rotation, and a connecting element coupled to said movable device and connected to said platform so that a motion of said movable device results in a rotation of said platform via the connecting element;
and in that the array further comprises an actuation system which is common to said tracking support systems, said actuation system being coupled to their mechanical drive systems via a mechanical transmission device extending parallel to the main axis of rotation, said transmission device being coupled to the movable devices of the mechanical drive systems of each tracking support system, so that the platforms are driven in rotation concomitantly by said actuation system by means of the transmission device and the mechanical drive systems.

15. The solar field according to claim 13, wherein:
a first solar array, and
a second solar array includes a transmission device rotatably coupling the mechanical drive systems of its tracking support systems in order to ensure a synchronous rotation of the platforms of these tracking support systems, said transmission device being coupled to the movable devices of the mechanical drive systems of each tracking support system of said second solar array;
and wherein the field further comprises at least one connection between the transmission device of the first array and the transmission device of the second array, so that the platforms of the second array are driven in rotation by the actuation system of the first array, concomitantly with the platforms of the first array, by means of the connection(s) between the two arrays.
